(19) United States
(12) Patent Application Publication
(10) Pub. No.: US 2008/0115316 A1
(43) Pub. Date: May 22, 2008

(54) Vacuum Having Wheels And Shock Absorbing Features

(76) Inventors: Gregg L. Sheddy, Shrewsbury, PA (US); Paul S. White, Towson, MD (US); Stuart J. Wright, Timonium, MD (US); Kathy E. DiPasquale, Baltimore, MD (US)

Correspondence Address: HARNESS, DICKEY & PIERCE, P.L.C., P.O. BOX 828, BLOOMFIELD HILLS, MI, 48303, US

(21) Appl. No.: 11/870,840

(22) Filed: Oct. 11, 2007

Related U.S. Application Data
(60) Provisional application No. 60/954,162, filed on Aug. 6, 2007.
(60) Provisional application No. 60/859,948, filed on Nov. 20, 2006.

(51) Int. Cl. A47L 9/00; B60B 33/00

(52) U.S. Cl. 15/354; 16/45

(57) ABSTRACT

A vacuum including a housing, a suction device disposed within the housing, at least one axle mounted to the housing at one or more mounting points, and a plurality of wheels mounted to the axle, wherein the axle is operable to flex about the one or more mounting points to absorb an impact force. The vacuum may also include at least one rail mounted to the housing at a plurality of mounting points and at least one caster wheel rotatably fixed to the rail. The at least one rail is operable to pivot about an axis partially defined by at least one of the mounting points in response to input forces, and a plurality of spring elements are operable to resist said pivoting, damping the input forces.

### CROSS-REFERENCE TO RELATED APPLICATIONS

This application claims the benefit of U.S. Provisional Application No. 60/954162 filed on Aug. 6, 2007, and U.S. Provisional Application No. 60/859,948 filed on Nov. 20, 2006. The disclosures of the above applications are incorporated herein by reference.

### FIELD

The present disclosure relates to vacuums and in particular to a vacuum with wheels and shock absorbing features.

### BACKGROUND

The statements in this section merely provide background information related to the present disclosure and may not constitute prior art.

Vacuums, particularly industrial shop vacuums, may be equipped with wheels to facilitate mobility and versatile use. These wheels are typically rigidly mounted to the vacuum. Impediments, debris, and other hazards are common to the intended operating environment of many vacuums. Impacts associated with dropping the vacuum or collisions with job site impediments can damage the wheels and their mounting components.

### SUMMARY

A vacuum including a housing, a suction device disposed within the housing, at least one axle mounted to the housing at one or more mounting points, and a plurality of wheels mounted to the axle. The axle is operable to flex about the one or more mounting points to absorb an impact force. The vacuum may also include at least one rail mounted to the housing at a plurality of mounting points and at least one caster wheel rotatably fixed to the rail. The at least one rail may be operable to pivot about an axis partially defined by at least one of the mounting points in response to input forces, and a plurality of spring elements are operable to resist the pivoting and damp the input forces.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a vacuum according to the principles of the present disclosure;

FIG. 2 is a bottom perspective view of a vacuum illustrating an axle and a rail according to the principles of the present disclosure;

FIG. 3 is a partial cross-sectional view illustrating the flexing motion of the axle shown in FIG. 2;

FIG. 4 is a cross-sectional view of a wheel according to the principles of the present disclosure;

FIG. 5 is a bottom view of the vacuum according to the principles of the present disclosure;

FIG. 6 is a partial exploded perspective view of the vacuum according to the principles of the present disclosure;

FIG. 7 is a partial perspective view of the vacuum according to the principles of the present disclosure;

FIG. 8 is a perspective view of a vacuum according to an alternative embodiment of the present disclosure;

FIG. 9 is a cross-sectional view of the shock absorber shown in FIG. 8;

FIG. 10 is a partial perspective view of a vacuum according to another embodiment of the present disclosure;

FIG. 11 is a perspective view of a vacuum according to yet another embodiment of the present disclosure;

FIG. 12 is a side view of the vacuum shown in FIG. 11;

FIG. 13 is a side view of a caster according to the principles of the present disclosure; and

FIG. 14 is a perspective view of a caster according to an alternative embodiment of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

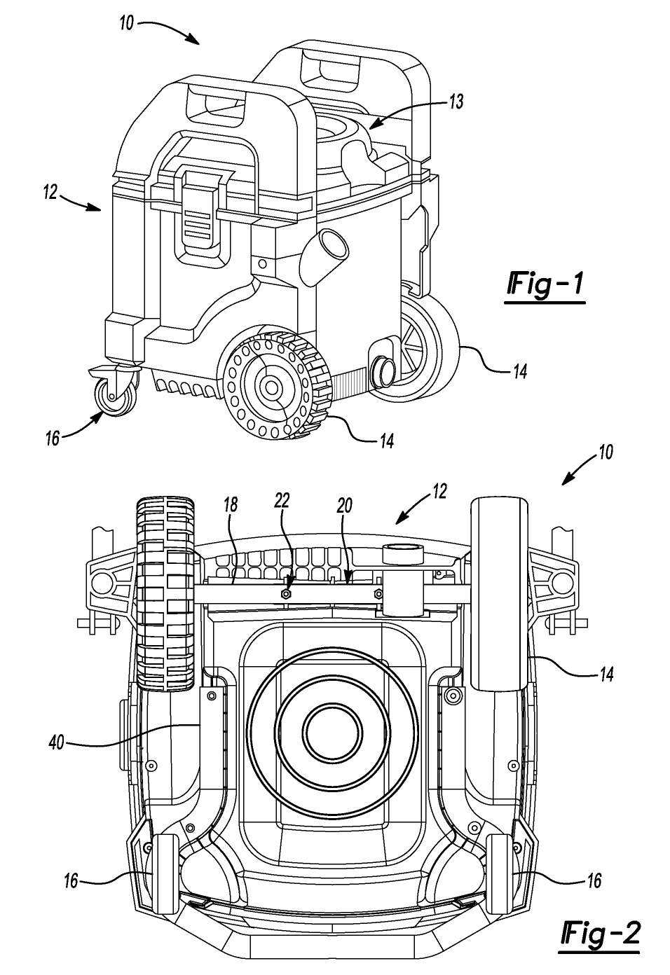

Referring to FIGS. 1-7, a vacuum with shock absorbing features is shown, and is generally referred to as vacuum 10. Vacuum 10 includes a housing 12 that encloses a suction device. Suction device is generally located within housing 12 at 13, and includes a mechanism that creates a suction force operable to collect dirt, debris, and other wet or dry waste matter, as known in the art. For example, suction device 13 may include an electric motor driving a suction fan (not shown). Vacuum 10 may include a plurality of wheels 14 and/or one or more caster wheel 16 to facilitate mobility and maneuverability.

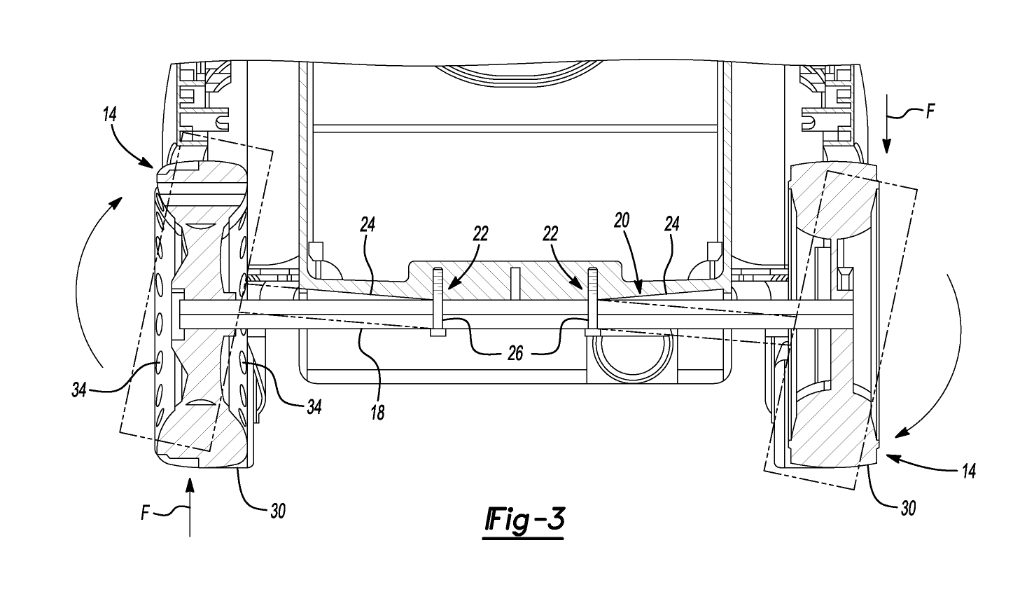

In an exemplary embodiment, wheels 14 are relatively larger than caster wheels 16. Wheels 14 are rotatably fixed to a flexible axle 18, as best shown in FIGS. 2 and 3. Axle 18 is appropriately fixed to housing 12, as subsequently described below. The material properties of axle 18 are such that axle 18 is operable to flex in response to a force F and spring back to its nominal configuration. Force F may be an impact to wheels 14 associated with dropping the vacuum 10, rolling the vacuum 10 over debris or uneven surfaces, or other harsh events known to occur.

Axle 18 is fixed within a groove 20, disposed on housing 12, at one or more mounting points 22, as best seen in FIG. 3. Axle 18 is operable to flex in multiple directions about mounting points 22, in response to force F. Tapered portions 24 of groove 20 allow clearance for axle 18 to flex in multiple directions, as shown in FIG. 3. Mounting points 22 are preferably located on the central third of the length of axle 18 to further facilitate flexing of axle 18. Bolts 26 may be disposed through axle 18 at mounting points 22 and threadably engaged with housing 12. It should be appreciated that axle 18 may be fixed within groove 20 by other methods known in the art, such as bonding, clamping, or interference-fitting.

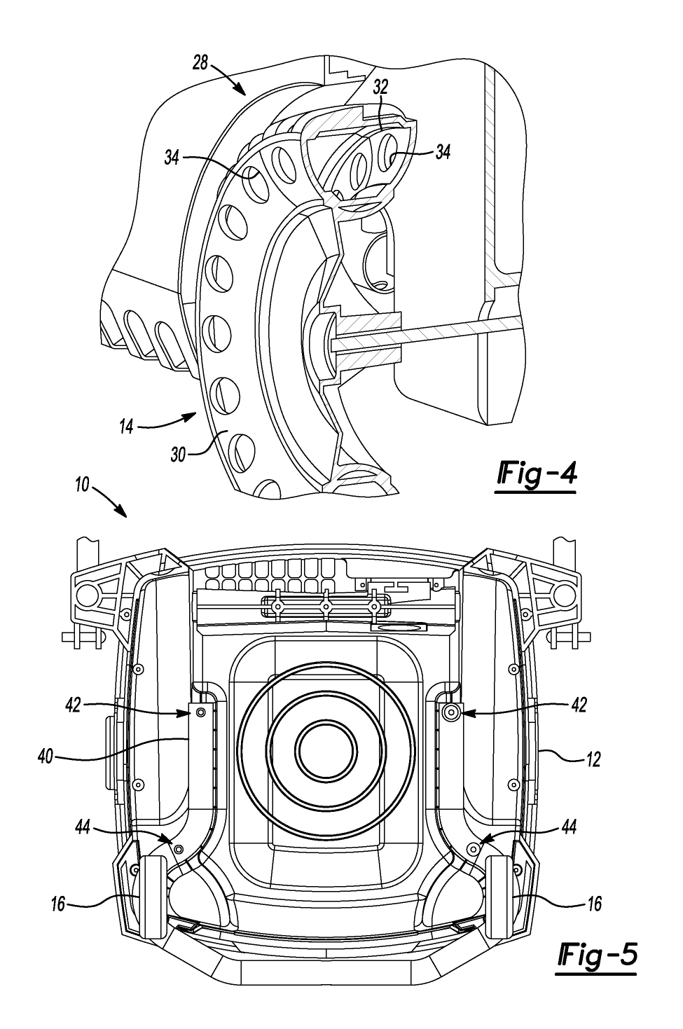

As shown best in FIG. 4, housing 12 includes wheel wells 28 partially encircling wheels 14. Wheel wells 28 have a diameter that is sufficiently large, relative to wheels 14, to allow axle 18 to flex in multiple directions without restriction.

Wheels 14 may include an elastomeric tire portion 30. Tire 30 is operable to compress in response to impact forces F and spring back to its nominal shape. In this manner, elastomeric tire 30 is operable to absorb impact energy, similar to the springing action of axle 18 described above. Tire 30 may also include a cavity 32, as shown in FIG. 4, to further enhance its elastic properties. The sidewalls of tire 30 may include a plurality of structural relief features 34 to further facilitate compression of tire 30 in response to impact force F. The structural relief features 34 may be openings extending through the entire cross-section of the tire 30, as shown in FIGS. 3 and 4.

Referring now to FIGS. 5-7, vacuum 10 may include at least one caster wheel 16 to improve the mobility and maneuverability of vacuum 10. Caster wheels 16 are rotatably fixed to a tubular rail 40. Rail 40 may be soft mounted to housing 12 to improve the overall resiliency of the vacuum 10.

In an exemplary embodiment, rail 40 is fixed to housing 12 at a first set of end mounting points 42, and a second set of intermediate mounting points 44. Bolts 46 are disposed through rail 40 at the mounting points 42, 44 and are threadably engaged either directly with housing 12 or with nuts (not shown) disposed within housing 12.

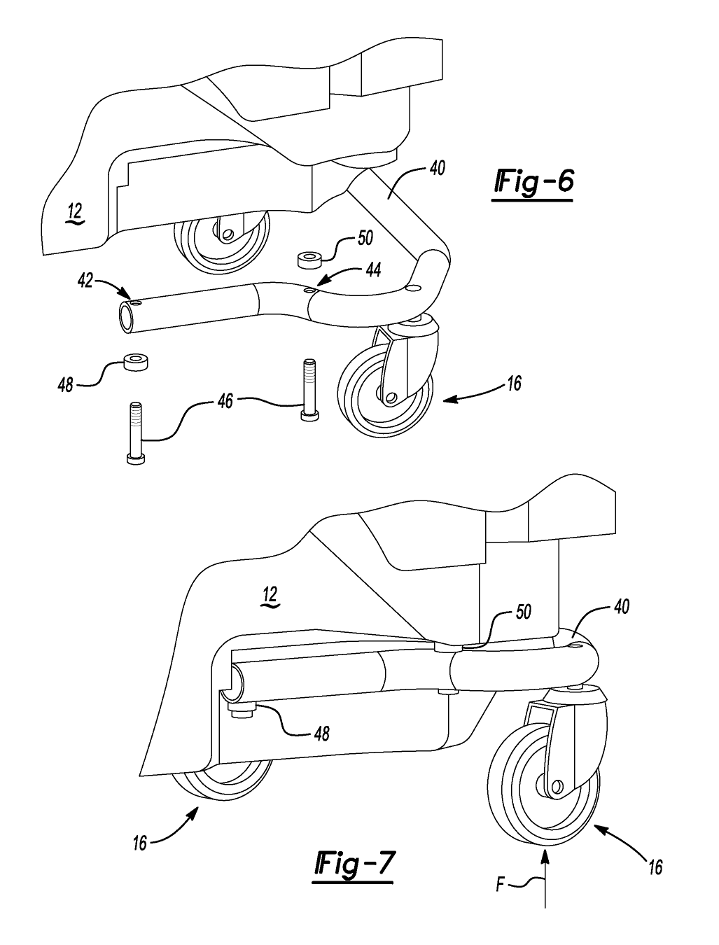

As best shown in FIG. 6, a first set of spring elements 48 are slidably engaged with bolts 46 and are disposed between rail 40 and the heads of bolts 46 at the end mounting points 42. A second set of spring elements 50 are slidably engaged with bolts 46 and are disposed between rail 40 and housing 12 at the intermediate mounting points 44. The intermediate mounting points 44 are disposed between the end mounting points 42 and the caster wheels 16. This allows rail 40 to flex and pivot about an axis defined by the intermediate mounting points 44 in response to impact force F. This causes compression of spring elements 48, 50, which resists the pivoting motion of rail 40 and damps the impact energy. This improves the survivability of caster wheels 16 and improves the overall impact resistance of vacuum 10. Spring elements 48, 50 may be elastomeric washers, helical compression springs, or any other resilient damping member. The caster wheels 16 can be made from solid plastic or rubber, or alternatively can be formed in the same manner as wheels 14, shown in FIG. 4.

Alternatively, the first set of spring elements 48 may be tension springs disposed at the end mounting points 42, between rail 40 and housing 12. In this configuration, spring elements 48 stretch in response to impact forces, resisting the pivoting action of rail 40 and damping impact energy.

In an alternative embodiment, vacuum 10 may include a plurality of rails. For example, each caster wheel 16 may be soft mounted to an independent rail, or a plurality of rails 40 may include a plurality of caster wheels 16.

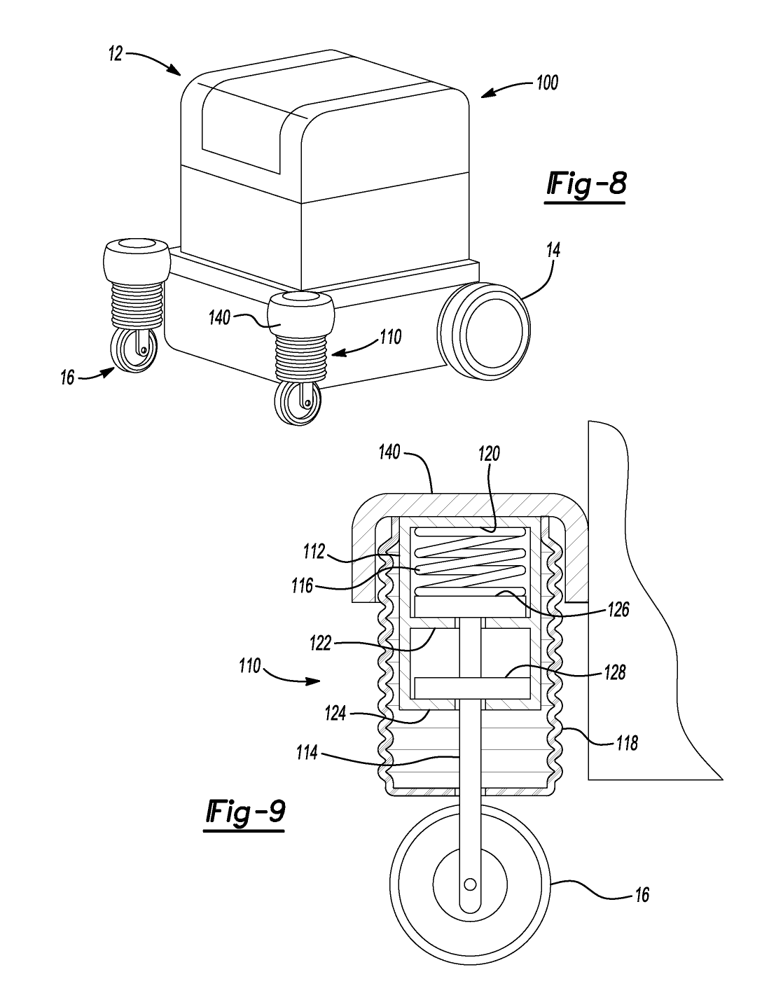

With reference to FIGS. 8-9, wherein common reference numerals are used to represent common elements as disclosed in FIGS. 1-7, an alternative embodiment is shown. Vacuum 100 includes a housing 12, wheels 14 and caster wheels 16. The caster wheels 16 are mounted to shock absorbers 110. It should be appreciated that wheels 14 may also be mounted to shock absorbers 110. The number and/or location of wheels 14 and caster wheels 16 may be varied to promote maneuverability, stability, and robustness.

Each shock absorber 110 is fixedly mounted to a support 140, which may be integrally formed with housing 12 or otherwise fixed thereto. As shown in FIG. 9, shock absorber 110 includes a cylindrical member 112, a stem 114 of caster wheel 16, and a compression spring 116. A flexible boot 118 may be disposed around the shock absorber 110 to prevent binding and wear of shock absorber 110.

Cylindrical member 112 includes an upper closed end 120, an intermediate flange 122 and a lower flange 124. Stem 114 includes an upper flange 126 disposed between upper closed end 120 and intermediate flange 122 of cylindrical member 112. Stem 114 also includes a lower flange 128 disposed between the intermediate flange 122 and the lower flange 124.

Stem 114 is slidably engaged with cylindrical member 112, and is rotatable therein to allow rotation of caster wheel 16, improving maneuverability of vacuum 100. Stem 114 may also support caster wheel 16 for rotation about a second axis perpendicular to the length of stem 114.

Compression spring 116 is disposed between upper closed end 120 of the cylindrical member 112 and the upper flange 126 of stem 114. Compression spring 116 is operable in this configuration to absorb impact energy as an impact force F drives stem 114 upward relative to cylindrical member 112. The range of upward travel of stem 114 is limited by the lower flange 128 of stem 114 abutting against the intermediate flange 122 of the cylindrical member 112. The downward travel of stem 114 is limited by the lower flange 128 of the stem 114 abutting against the lower flange 124 of the cylindrical member 112.

Compression spring 116 may be a metallic helical spring. In an alternative embodiment, shock absorber 110 may include a plurality of compression springs 116. In another embodiment, compression spring 116 may be a compressible elastomeric member. In yet another embodiment, compression spring 116 may be a pneumatic or hydraulic impact damping device.

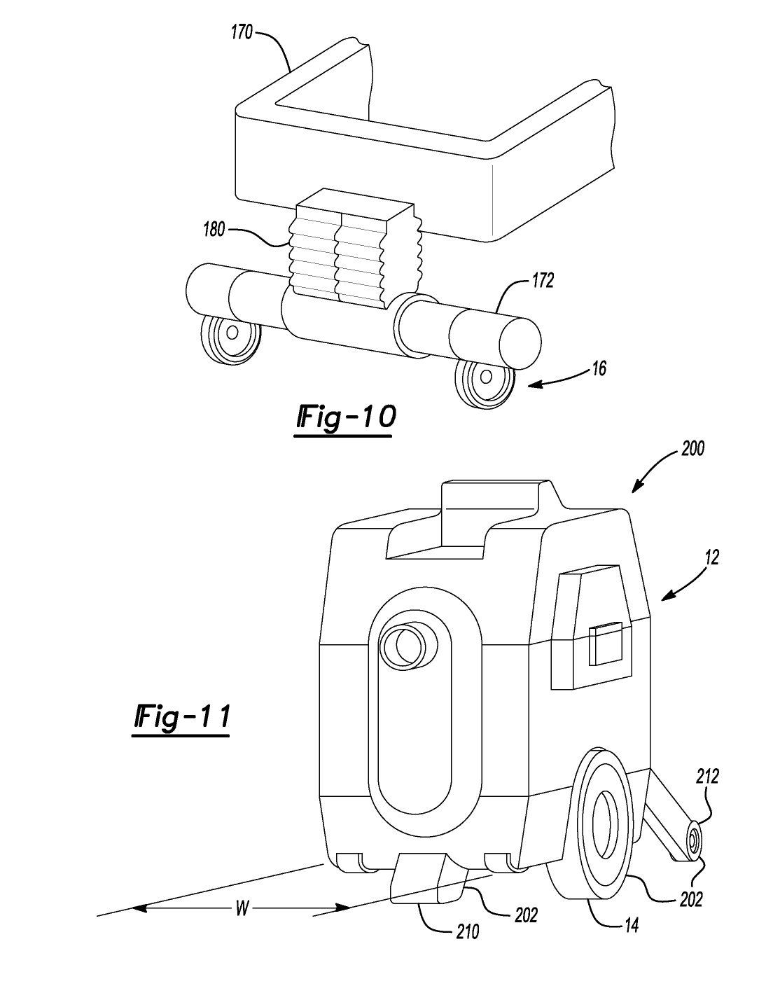

Referring now to FIG. 10, an alternative embodiment of vacuum 100 is shown wherein a housing (not shown) may be supported by a frame 170. Frame 170 may extend around the entire periphery of the housing. Further, the housing and frame 170 may be configured to allow easy removal of the housing from frame 170 for disposal of waste matter that has been collected during use of the vacuum 100.

Frame 170 may include a plurality of wheels 14 and/or caster wheels 16. Caster wheels 16 are rotatably mounted on a bracket 172. Bracket 172 is fixed to frame 170 via a shock absorber 180. Shock absorber 180 may be configured similarly to any of the embodiments of shock absorber 110 described above. Additionally, shock absorber 180 may include structure to prevent a relative rotation between frame 170 and bracket 172.

With reference to FIGS. 11-14, wherein common reference numerals are used to represent common elements as disclosed in FIGS. 1-10, a vacuum 200 is shown. Vacuum 200 includes a housing 12, an internal suction device 13, and a plurality of movement-support members 202. Movement-support members 202 may include ball-and-socket arrangements, bearings, casters, low-friction surfaces, rollers, wheels, and/or other devices known in the art.

In an exemplary embodiment, movement-support members 202 include wheels 14 and at least one of a front support 210 and a rear support 212. Wheels 14 may be disposed on an axis located at or near the center of a length L of housing 12. Front support 210 and rear support 212 are disposed at or near the center of a width W of housing 12.

Either or both of front support 210 and rear support 212 may be adjustable to move upward relative to a floor or ground on which the vacuum 200 is situated. In this configuration, vacuum 200 is operable to move relative to a floor or ground, while the floor or ground is in contact only with wheels 14. In this configuration, vacuum 200 is operable to maneuver over and/or around many common job site impediments such as electrical cable, hoses, boards, or other equipment or debris.

Either or both of the front support 210 or the rear support 212 may contact the floor or ground during movement to provide additional stability and/or support for vacuum 200.

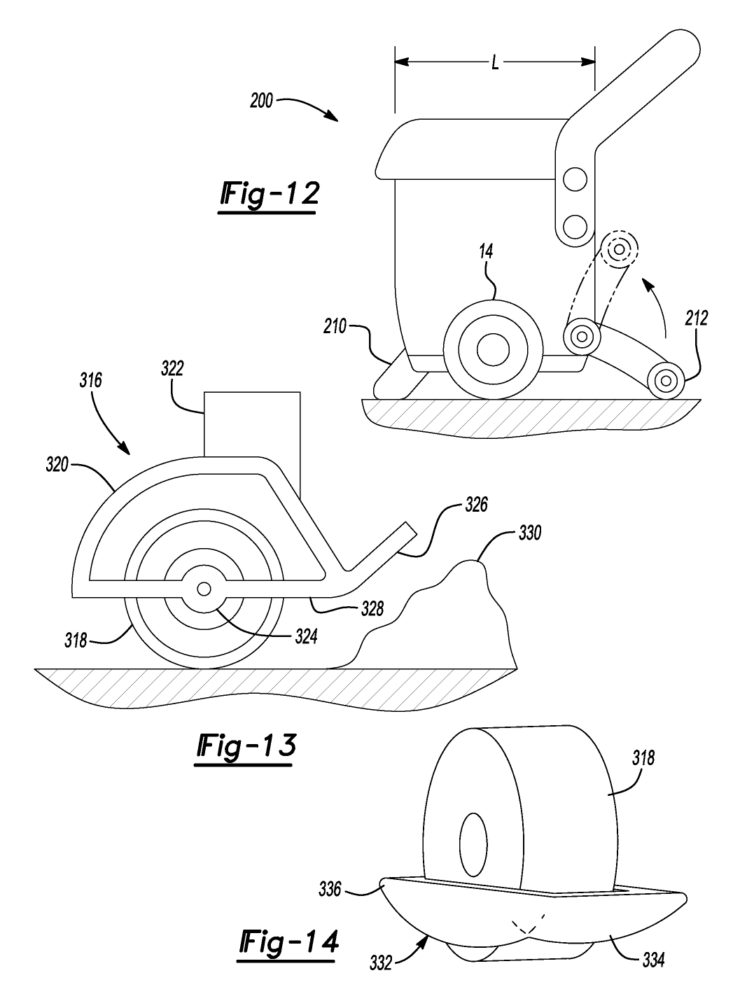

As shown in FIGS. 13-14, vacuum 10, 100, 200 may include at least one caster 316. Caster 316 includes a wheel 318, support 320, and pivot device 322. Wheel 318 is operatively connected to support 320. This connection may be a direct connection between wheel 318 and support 320, or the connection may be an indirect connection via axle 324. Support 320 and wheel 318 are rotatably fixed to device 322 to facilitate maneuverability of vacuum 10, 100, 200.

In an exemplary embodiment, support 320 at least partially surrounds wheel 318 and is operable to shield wheel 318 from damaging impacts and debris. Support 320 includes an inclined surface 326 and a lower surface 328 operable to deflect a job site impediment 330 away from caster 316, thus reducing the risk of damage to caster 316 and reducing the need to avoid impediments.

Alternatively, caster 316 may include a deflector 332, as shown in FIG. 14. Deflector 332 may include a first contoured surface 334 and a second contoured surface 336. Contoured surfaces 334, 336 are oriented relative to each other and to wheel 318 to facilitate defection of job site impediments, reducing risk of damage to caster 318.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vacuum comprising:
a housing;
a suction device disposed within said housing;
at least one axle mounted to said housing at one or more mounting points; and
a plurality of wheels mounted to said at least one axle,
wherein said at least one axle is operable to flex about said one or more mounting points to absorb an impact force.

2. The vacuum according to claim 1, wherein said one or more mounting points are disposed on the central third of the length of said at least one axle.

3. The vacuum according to claim 1, wherein said at least one axle is operable to flex in a plurality of directions.

4. The vacuum according to claim 1, wherein said wheels are operable to compress in response to an impact load.

5. The vacuum according to claim 1, wherein said wheels are at least partially elastomeric.

6. The vacuum according to claim 1, wherein a plurality of holes are disposed through the side walls of said wheels facilitate impact energy absorption.

7. The vacuum according to claim 1, wherein said wheels include a cavity to facilitate compression.

8. The vacuum according to claim 1, further comprising at least one caster wheel and a plurality of relatively large wheels.

9. The vacuum according to claim 1, wherein said at least one caster wheel is mounted to a pivotable rail.

10. The vacuum according to claim 1, wherein said housing includes wheel wells with sufficient clearance around said wheels to allow said at least one axle to freely flex in a plurality of directions.

11. A vacuum comprising:
a housing;
a suction device disposed within said housing;
at least one axle mounted to said housing;
at least one groove disposed on said housing to receive said at least one axle with a clearance therebetween; and
a plurality of wheels mounted to said at least one axle,
wherein said at least one groove includes at least one tapered portion to allow said at least one axle to flex to absorb an impact force.

12. The vacuum according to claim 11, wherein said housing includes wheel wells with sufficient clearance around said wheels to allow said at least one axle to freely flex in a plurality of directions.

13. A vacuum comprising:
a housing;
a suction device disposed within said housing; and
a plurality of wheels mounted to said housing,
wherein the sidewalls of at least one of said wheel includes a plurality of structural relief features to facilitate compression of said wheels.

14. The vacuum of claim 13, wherein said structural relief features are openings extending through the sidewalls of said wheels.

15. The vacuum of claim 13, wherein said wheels are at least partially elastomeric.

16. The vacuum of claim 13, wherein said wheels include a cavity to further facilitate compression of said wheels.

17. A vacuum comprising:
a housing;
a suction device disposed within said housing;
at least one rail mounted to said housing at a plurality of mounting points; and
at least one caster wheel rotatably fixed to said rail,
wherein said at least one rail is operable to pivot about an axis partially defined by at least one of said mounting points in response to input forces, and a plurality of spring elements are operable to resist said pivoting and damp said input forces.

18. The vacuum according to claim 17, wherein said spring elements are slidably engaged with bolts.

19. The vacuum according to claim 17, wherein said spring elements are elastomeric washers.

20. The vacuum according to claim 17, wherein said spring elements are helical compression springs.

21. The vacuum according to claim 17, wherein at least one of said spring elements is a tension spring.

22. The vacuum according to claim 17, wherein said at least one rail is tubular.

23. The vacuum according to claim 17, wherein said at least one caster wheel is at least partially elastomeric.

24. The vacuum according to claim 23, wherein said at least one caster wheel includes a cavity to facilitate impact energy absorption.

25. The vacuum according to claim 23, wherein a plurality of holes are disposed through the sidewalls of said caster wheels to facilitate impact energy absorption.
